(19) United States
(12) Patent Application Publication
(10) Pub. No.: US 2004/0166481 A1
(43) Pub. Date: Aug. 26, 2004

(54) Linear listening and followed-reading language learning system & method

(76) Inventors: Sayling Wen, Taipei (TW); Zechary Chang, Taipei (TW); Pinky Ma, Beijing (CN)

Correspondence Address: BIRCH STEWART KOLASCH & BIRCH, PO BOX 747, FALLS CHURCH, VA, 22040-0747, US

(21) Appl. No.: 10/372,797

(22) Filed: Feb. 26, 2003

(51) Int. Cl. G09B 5/00

(52) U.S. Cl. 434/169; 434/308; 434/321

(57) ABSTRACT

A linear listening and followed-reading language learning system & method, used to linearly adjust the play back speed of the training specimen according to the play back frequency of the training specimen, allowing the user to gradually adapt to the play back speed of the training specimen through progressive training mode, so as to meet the objective of language learning; the system disclosed by this invention comprises a training database, a theme-drawing module, a followed-reading play back module and a speech rate adjustment module; the method flow disclosed by this invention comprises the following steps: first, perform the parameter initialization, then, after picked the training specimen, start the training specimen's play back task, and during this course prompt the user to follow-read and record the followed-reading speech material of the user, and then play back this training specimen and the user's this followed-reading speech material respectively, adjust the speech rate parameter according to the training specimen's play back frequency until the end of the training specimen's play back task, complete all step flows of the method.

### BACKGOUND OF THE INVENTION

1. Field of Invention

This invention is a kind of linear listening and followed-reading language learning system & method, especially referring to a computer aided foreign language listening & teaching training, it allows the user to accelerate the training specimen's play back speed with the growth of the training specimen's play back frequency in the followed-reading learning process, to perform the system & method of the listening training.

2. Related Art

Listening & speaking are fundamental language skills. Therefore, in the initial language learning stage, the learning of listening & speaking is very important. In foreign language learning, the top priority of listening comprehension learning lies in the cultivation of speech-distinguishing ability, one must be able to distinguish the phonetic features endowed with the speech message uttered by a foreign language speaker; the next is to convert these phonetic features into ideas represented via brain comprehension. When using new language teaching-material, the learner often has big problems in distinguishing and converting ideas, because people speak too fast on teaching-tapes or cd's. On the one hand, he (or she, the same below) cannot identify the phonetic feature details of the heard foreign language; on the other hand, he cannot understand the meaning represented by these speech signals frequently entering his brain either.

Anyone who has learned how to play a music instrument can have such an experience: when playing complex melodies, most musicians may break a full-length of melody into several subsections, and first play with a slower speed; after several exercises, when they can accurately play every musical note according to the organizing order of these musical notes, they gradually cohere the play of every subsection and add some additional play skills.

This progressive learning mode is also applicable in a language learning process. When the learner initially uses new language teaching-material, it is preferable to do it this way: first, present the phonetic features completely & clearly at a slow speed to the learner, and only after the learner has had a preliminary identification and understanding of this speech, accelerate gradually its speed The more this speech is played back to the learner, the faster the presentation speed of this speech; through this mode, when this speech is played back at normal speed, the learner has already an above-average listening-comprehension and understanding There are many language learning tools on the market, but they are all limited to the following: the language learning teaching-material can only be played back at the play back speed or at the speed adjusted by the user himself, we cannot find an effective tool with a play back speed set up through the system and gradually changed after each play back exercise, to attain the adaptive learning objective.

### SUMMARY OF THE INVENTION

This invention is proposed to solve the above-mentioned problem, it is a linear listening and followed-reading language learning system & method, whose main objective lies in: (with the growth of the training specimen's play back frequency) gradually elevating the training specimen's play back speed, and allowing the user to meet the objective of language learning through this adaptive followed-reading learning process.

Therefore, to reach the above-mentioned goal, the linear listening and followed-reading language learning system of this invention comprises: a theme-drawing module that picks the training specimen from the training database, then the followed-reading play back module plays back, and then the speech rate adjustment module gradually elevates the play back rate of the training specimen in line with the play back frequency.

The linear listening and followed-reading language learning system of this invention comprises the following steps: first, perform the parameter initialization; after picking of the training specimen, start the training specimen's play back task, and during this course prompt the user to follow-reading and recording the user's followed-reading speech material, then play back this training specimen and the user's followed-reading speech material respectively; finally, adjust the speech rate parameter according to the training specimen's play back frequency until the training specimen's play back task is ended, complete the whole method

### BRIEF DESCRIPITION OF THE DRAWINGS

FIG. 1 is the system structure drawing of this invention

FIG. 2 is the method flow chart of this invention

### DESCRIPTION OF THE PREFERRED EMBODIMENT

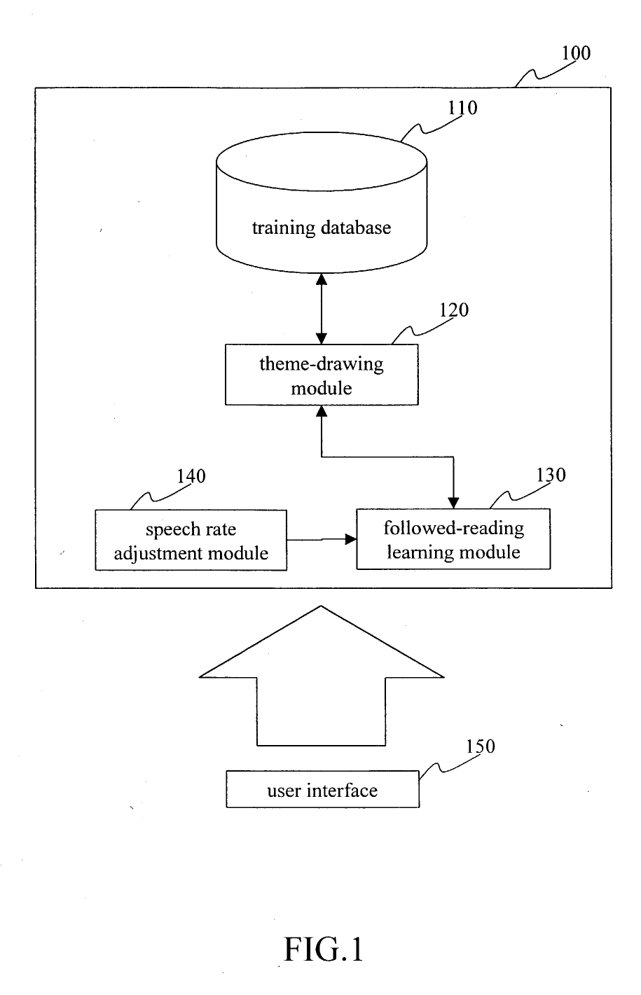

This invention is a kind of linear listening and followed-reading language learning system & method. Referring to FIG. 1: (1) Training database 110, used to store all theme-drawing training specimen, every training specimen comprises a training specimen serial number (picked through the theme-drawing module 120), a demonstration speech content and a training specimen graphics context content (which comprises: words, images, pictures and other multimedia content), mainly served as the theme-drawing content when the user performs the followed-reading learning process.

(2) Theme-drawing module 220, used to perform selections from the training database 110 and pick the correct theme-drawing training specimen. The theme-drawing module 120 will, according to the theme category preset by the user through the user's operation interface 200 or setup by the user based on his degree/grade (in the linear listening and followed-reading language learning system 100), such as the repetitive play back frequency of the training specimen and the training specimen's initial speech rate parameter, perform the action of theme-drawing in line with the setting; the number generated through the mode of random number is used as the main basis for the training specimen, to pick the comparative pair.

(3) The followed-reading learning module 130, mainly used to execute the training specimen picked by the theme-drawing module 120 for the user, to perform the followed-reading learning process; perform through this followed-reading learning module 130, and everything will be performed according to the user's parameter-setup content in the linear listening and followed-reading language learning system 100 through the system initialization results; after playing back and executing the training specimen, collect & record this speech sample in this process (while focusing on listening); after followed-reading of a batch of the training specimen, the demonstration speech and the training specimen graphics context content, the user's followed-reading speech material is used to complete this followed-reading learning flow.

(4) The dynamic parameter setup module 140, used in the user's followed-reading learning process, for adjusting the demonstration speech play back speed of the training specimen according to the user's buildup speech material play back frequency; its process will change the speech wave form cycle of the demonstration speech, based on fixed proportion through the dynamic parameter setup module 140, and accelerates the play back speed of the demonstration speech based on fixed proportion.

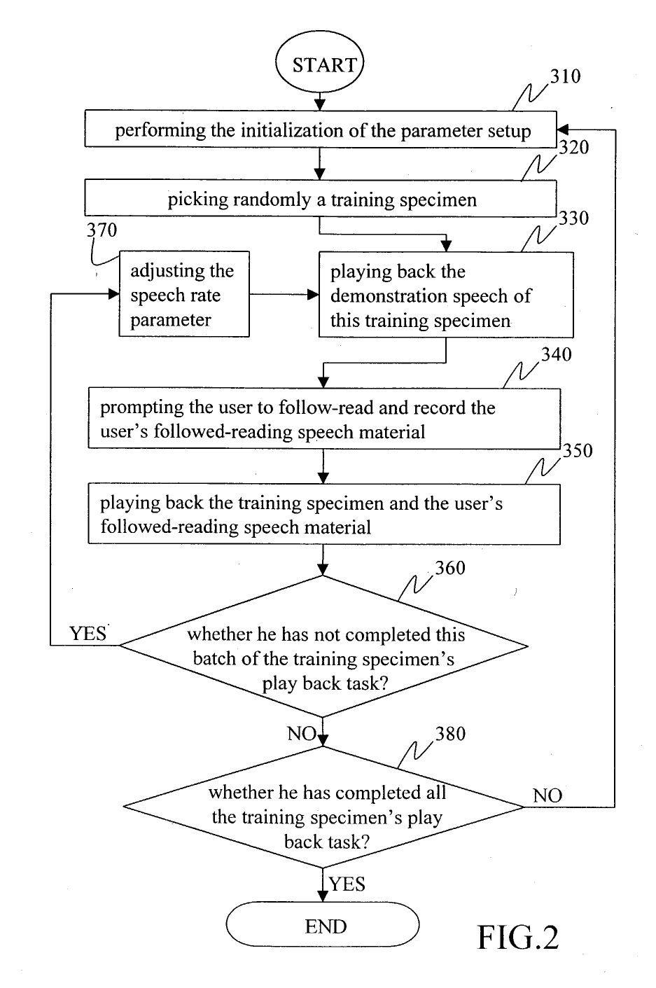

We use a part of FIG. 2, which is the operation flow chart of the system & method of the linear listening and followed-reading language learning system of this invention, to describe the main operation flow of the linear listening and followed-reading language learning system 100 of this invention as follows:

First, activate the linear listening and followed-reading language learning system 200 of this invention: the system automatically performs the initialization of the parameter setup (step 310). That means, using the user's preset default in the theme-drawing module 120 (such as performing setup action to the repetitive play back frequency and initial speech rate parameters,), do this with every modular unit; then, when the user starts listening training, the theme-drawing module 120 will, according to the setup theme-drawing category and the user's degree & ability, pick randomly a training specimen (step 320) from the training database 210, then play back the demonstration speech of this training specimen (step 330) to allow the user to start perform followed-reading learning process; the followed-reading play back module 130 will prompt the user to follow-read and record the user's followed-reading speech material (step 340). When the user has ended the record task of the speech material, the system will play back the training specimen and the user's followed-reading speech material (step 350) respectively, and provides the demonstration of the user's contrast imitation, to correct the user's intonation & pronunciation and learn the content of this training. After played back, the system will, according to the original repetitive play back frequency setup by the user before the play back, judge whether he has not completed this batch of the training specimen's play back task (step 360). If the user's preset play back frequency has not been met, the speech rate adjustment module 140 will adjust the speech rate parameter (step 370). That is, to change the speech wave form cycle of the demonstration speech through the dynamic parameter setup module 140 based on fixed proportion, thus to start accelerating the speed of the play back demonstration speech from the user's preset initial speech rate parameter based on fixed proportion; it restarts playing back the training specimen (step 330), follow the above-mentioned flow, until it has judged the result “whether he has not completed this batch of the training specimen's play back task (step 360)”. If the answer is NO, the system may further judge whether he has completed all the training specimen's play back task (step 380). If NO, the system will go back to perform the parameter start (step 310), until it has judged the result “whether he has completed all the training specimen's play back task (step 380)”. If the answer is YES, it ends this linear listening and followed-reading language learning method flow.

The linear listening and followed-reading language learning system & method of this invention is to ( according to the user's setup frequency of the demonstration speech in the play back training specimen and through gradually elevated play back speed) allow the user to attain an optimal language learning effect.

What is claimed is:

1. A linear listening and followed-reading language learning system used to, according to a play back frequency of the training specimen, linearly adjust the training specimen's play back speed through progressive mode, allowing the user to gradually adapt to the speed of the training specimen and to meet the objective of language learning, wherein this system comprises:
a training database, used to store a batch of this foregoing training specimen and provide a followed-reading learning process for the user to perform;
a theme-drawing module, used to select and pick this training specimen from this training database;
a followed-reading learning module, when the user performs this followed-reading learning process, used to collect & record a user's followed-reading speech material, and play back this theme-drawing-module-picked training specimen and the user's this followed-reading speech material respectively; and
a speech rate adjustment module, used to linearly adjust this training specimen's play back speed according to the play back frequency of this training specimen.

2. The linear listening and followed-reading language learning system according to claim 1, this training specimen comprises at least a training specimen serial number, a demonstration speech and a training specimen graphics context content.

3. The linear listening and followed-reading language learning system according to claim 1, this speech rate adjustment module will increase this training specimen's play back speed with the increase of the play back frequency.

4. A linear listening and followed-reading language learning method used to, according to a play back frequency of the training specimen, linearly adjust the training specimen's play back speed through progressive mode, allowing the user to gradually adapt to the speed of the training specimen and to meet the objective of language learning, where this comprises the following steps:
(a) perform a parameter initialization;
(b) pick this training specimen;
(c) start a training specimen's play back task;
(d) prompt the user to follow-read and record the user's followed-reading speech material;
(e) play back this training specimen and the user's this followed-reading speech material respectively; and
(f) adjust the speech rate parameter;
wherein above-mentioned step (c), if this training specimen's play back task has not completed, it will repeat step (c) to (f).

5. The linear listening and followed-reading language learning method according to claim 4, wherein this training specimen in this step (b) comprises at least a training specimen serial number, a demonstration speech and a training specimen graphics context content.

6. The linear listening and followed-reading language learning method according to claim 4, wherein the play back task of this training specimen in this step (c) will, through the initialization step of this parameter, perform the setup action to a repetitive play back frequency and an initial speech rate parameter of this training specimen.
